(19) United States
(12) Patent Application Publication
(10) Pub. No.: US 2017/0353130 A1
(43) Pub. Date: Dec. 7, 2017

(54) DEVICE FOR CORRECTING HALL SENSOR INSTALLATION POSITION ERROR OF BLDC MOTOR HAVING LINEAR HALL SENSOR, AND METHOD THEREOF

(71) Applicant: FIRSTEC CO., LTD., Changwon-si (KR)

(72) Inventor: Kon-kuk PARK, Changwon-si (KR)

(21) Appl. No.: 15/173,657

(22) Filed: Jun. 5, 2016

(51) Int. Cl. H02P 6/16

(52) U.S. Cl. CPC H02P 6/16

(57) ABSTRACT

There is provided a device for correcting a Hall sensor installation position error in a BLDC motor which includes a rotor with a permanent magnet, a stator wound with coils to form a magnetic field around the rotor, and three linear Hall sensors installed outwardly around the rotor to generate output signals by the Hall-Effect, the device comprising: a detection unit to detect output signals H₁, H₂, H₃ output from the three linear Hall sensors; a transformation unit to transform the output signals H₁, H₂, H₃ detected in the detection unit to orthogonal two-phase transformation signals Hₐ, H_{b} and to transform the transformation signals Hₐ, H_{b} to normalized transformation signals Hₐₙ, H_{bn}; an operation unit to calculate a rotation angle of the motor from the normalized transformation signals Hₐₙ, H_{bn} output in the transformation unit; and a control unit to control the current supplied to the coils winding the stator based on information of the rotation angle transmitted from the operation unit, wherein the transformation unit transforms the output signals H₁, H₂, H₃ to the orthogonal two-phase transformation signals Hₐ, H_{b} by Clarke Transformation.

### BACKGROUND OF THE INVENTION

### 1. Field of the Invention

The present invention relates to a BLDC motor and more particularly, to a device for correcting a Hall sensor installation position error when a linear Hall sensor is used in the BLDC motor to detect a rotor's position and rotation speed, and a method thereof.

### 2. Description of the Related Art

A BLDC (Brushless Direct Current) motor does not have a brush which an ordinary DC (Direct Current) motor has. A rotor is provided with a permanent magnet is driven by a magnetic force formed by the current supplied to winding coils of a stator. Since the BLDC motor does not have mechanical friction accompanied in a motor structure including the conventional brush, it enables high speed and high efficient driving, reduces noise and vibration and has excellent durability. Due to these merits, the BLDC motors are widely applied in diverse fields, such as many electronic products, medical instruments, military supplies, etc.

The stator in the BLDC motor is generally wound with three or more coils and the current controlled in a rectifier circuit is supplied to each coil. Since the current is supplied to the three or more coils needs to be controlled according to the rotor's position, a Hall-Effect sensor (called “Hall sensor”) is used to detect the position of the rotor. Referring to FIG. 1, generally, a BLDC motor 10 is provided with three Hall sensors h_{A}, h_{B}, h_{C} around a rotor R. The Hall sensors h_{A}, h_{B}, h_{C} output ‘0’ (Low) and ‘1’ (High) signals by the magnetic field which varies when the rotor R with the permanent magnet rotates. When the signals detected in the three Hall sensors h_{A}, h_{B}, h_{C} are referred as A, B, C in order, six signals, for example, 100, 110, 010, 011, 001, 101, are repetitively output in order according to the rotation of the rotor R. Since 000 or 111 cannot be output in the arrangement of the three Hall sensors h_{A}, h_{B}, h_{C}, the position of the rotor R is detected by the unit of 60° (degrees) by the six signals, whereby the current supplied to the stator is controlled.

The Hall sensors h_{A}, h_{B}, h_{C} which are used in the aforementioned conventional BLDC motor 10 are the latch-type Hall sensors to output digital signals. When the latch-type Hall sensors are used, there is no big problem in calculating the rotor's position or rotation speed in the high-speed driving section. However, since the position of the rotor R is detected by the unit of 60° (degrees) as described above, it is difficult to accurately calculate the rotor's position or rotation speed in the low-speed driving section.

To solve the aforementioned problem, the inventor of the present invention, Chi-Young SONG, described a “brushless DC motor using a linear Hall sensor and a method of realizing a speed signal of the motor” in Korean Patent Published Application No. 10-2008-0097732 (hereinafter, referred to as “'732 patent application”). In reference to the '732 patent application, the three Hall sensors h_{A}, h_{B}, h_{C} installed in the BLDC motor have sine wave outputs with a phase difference of 120° (degrees). When the outputs of the three Hall sensors h_{A}, h_{B}, h_{C} are converted as the coordinates on the two dimensional plane and P(x₁+x₂, y₁+y₂), which is the sum of coordinates (x₁, y₁) on signal A and coordinates (x₂, y₂) on signal B, forms an angle (θ) with the X-axis, the displacement of the angle (θ) is represented by Formula (1).

$$θ = {tan}^{- 1} ( \frac{{y}_{1} + {y}_{2}}{{x}_{1} + {x}_{2}} ) \times \frac{180}{π} , ( θ = \vert θ \vert , 0 ° \leq θ < 90 ° ) \qquad Formula ( 1 )$$

The displacement of the angle (θ) by Formula (1) indicates the displacement of the rotor and the speed of the rotor is calculated by calculating a change rate of the calculated displacement to the time. Further, as described in the '732 patent application, even though P(x₁+x₂, y₁+y₂) is in any of quadrant 1, 2, 3 and 4, it is possible to calculate the displacement of the angle (θ) and the speed.

As described above, the method using the linear Hall sensors has made it possible to accurately calculate the position and speed of the rotor, compared with the conventional method using the latch-type Hall sensors. Especially, when it is necessary to calculate the position and speed of the motor in the low-speed driving section, the method using the linear Hall sensors has been usefully applied.

In general, the linear Hall sensor has output voltage which is linearly proportional to magnetic flux density (see FIG. 2). The magnetic flux density applied to the linear Hall sensor is in inverse proportion to a distance, an effective air gap (EAG), from the permanent magnet installed in the rotor (see FIG. 3). Therefore, when the linear Hall sensor is used for the BLDC motor in the conventional art, if there is an error in the position where the linear Hall sensor is installed, the output voltage of the linear Hall sensor drastically changes. In reference to FIG. 4, preferably, three linear Hall sensors H1, H2, H3 each form the angle 120° (degrees) with the center of the rotor and distances d₁, d₂, d₃ spaced apart from the rotor are the same. It is most ideal that output signals H₁, H₂, H₃ detected when the three linear Hall sensors H1, H2, H3 are installed at normal position are in the form of sign waves having the phase difference of 120°(degrees), as shown in FIG. 5. However, it is very difficult to realistically install the linear Hall sensors at normal positions, without any errors, due to many factors that may occur during the process of manufacturing the motor. Moreover, reducing an error in installing the linear Hall sensors acts as a factor increasing the unit cost of the motor.

However, if an error occurs in the installation position of the linear Hall sensors, the problem is that it is impossible to accurately measure the position and rotation speed of the motor.

### PATENT DOCUMENT

(Patent Document 0001) Korean Patent Published Application No. 10-2008-0097732

### SUMMARY OF THE INVENTION

Therefore, it is an object of the present invention to solve the above problems and to provide a device for correcting a Hall sensor installation position error in a BLDC motor with the linear Hall sensor and a method thereof, to accurately calculate the position and speed of the motor even if an error exists in the Hall sensor installation position.

It is another object of the present invention to provide a device for correcting a Hall sensor installation position error and a method thereof, to accurately calculate the position and speed of the motor, without physically changing the Hall sensor installation position.

In accordance with an embodiment of the present invention, there is provided a device for correcting a Hall sensor installation position error in a BLDC motor which includes a rotor with a permanent magnet, a stator wound with coils to form a magnetic field around the rotor, and three linear Hall sensors installed outwardly around the rotor to generate output signals by the Hall-Effect, the device comprising: a detection unit to detect output signals H₁, H₂, H₃ output from the three linear Hall sensors; a transformation unit to transform the output signals H₁, H₂, H₃ detected in the detection unit to orthogonal two-phase transformation signals Hₐ, H_{b} and to transform the transformation signals Hₐ, H_{b} to normalized transformation signals Hₐₙ, H_{bn}; an operation unit to calculate a rotation angle of the motor from the normalized transformation signals Hₐₙ, H_{bn}, output in the transformation unit; and a control unit to control the current supplied to the coils winding the stator based on information of the rotation angle transmitted from the operation unit, wherein the transformation unit transforms the output signals H₁, H₂, H₃ to the orthogonal two-phase transformation signals Hₐ, H_{b} by Clarke Transformation.

In accordance with another embodiment of the present invention, there is provided a method for correcting a Hall sensor installation position error in a BLDC motor which includes a rotor with a permanent magnet, a stator wound with coils to form a magnetic field around the rotor, and three linear Hall sensors installed outwardly around the rotor to generate output signals by the Hall-Effect, the method comprising: a detecting step of detecting output signals H₁, H₂, H₃ output from the three linear Hall sensors; a transforming step of transforming the output signals H₁, H₂, H₃ detected at the detecting step to orthogonal two-phase transformation signals Hₐ, H_{b} and transforming the transformation signals Hₐ, H_{b} to normalized transformation signals Hₐₙ, H_{bn}; an operating step of calculating a rotation angle of the motor from the normalized transformation signals Hₐₙ, H_{bn} output in the transformation unit; and a controlling step of controlling the current supplied to the coils winding the stator based on information of the rotation angle transmitted from the operation unit, wherein the transforming step is performed by Clarke Transformation.

### Advantageous Effects of the Invention

The device and method for correcting a Hall sensor installation position error according to the present invention has the effect of accurately calculating the rotation angle and speed of the motor even though an error is in the Hall sensor installation position.

Further, in the case of using the device and method for correcting a Hall sensor installation position error according to the present invention, it is possible to accurately calculate the rotation angle of the motor, without physically modifying an error in the Hall sensor installation position, and therefore the unit cost of the motor is reduced.

### BRIEF DESCRIPTION OF THE DRAWINGS

The above and other features and advantages of the present invention will become more apparent to those of ordinary skill in the art by describing in detail the preferred embodiments thereof with reference to the attached drawings in which:

FIG. 1 is a schematic view of a structure of a general BLDC motor;

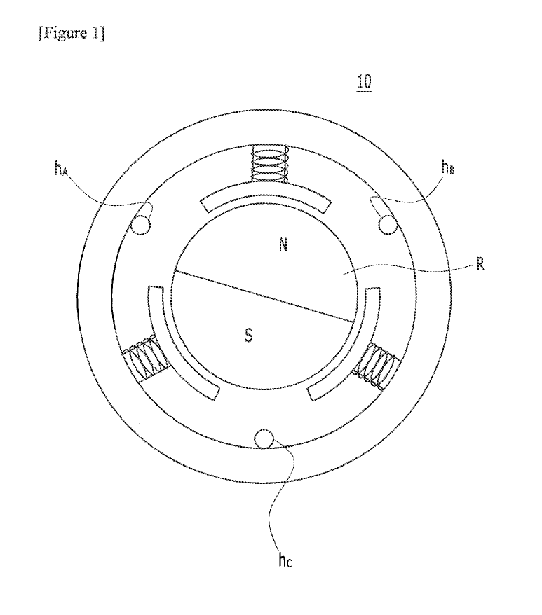

FIG. 2 is a graph showing the relation of the magnetic flux density applied to a Hall sensor(s) and the output voltage of the Hall sensor(s) accordingly;

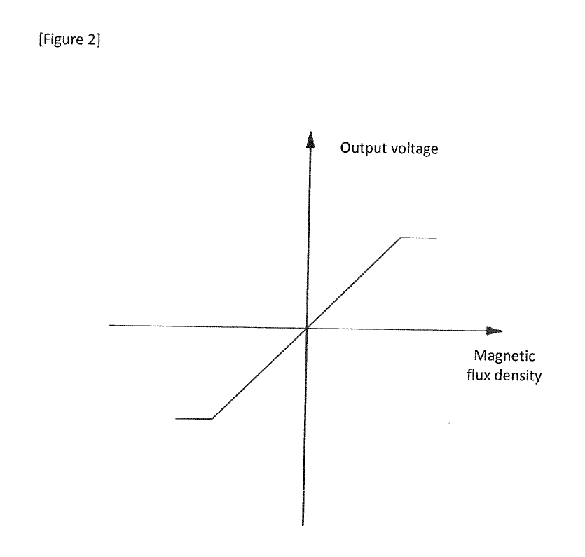

FIG. 3 is a graph showing the relation of the EAG from the Hall sensor(s) to a permanent magnet and the magnetic flux density which the permanent magnet influences on the Hall sensor(s);

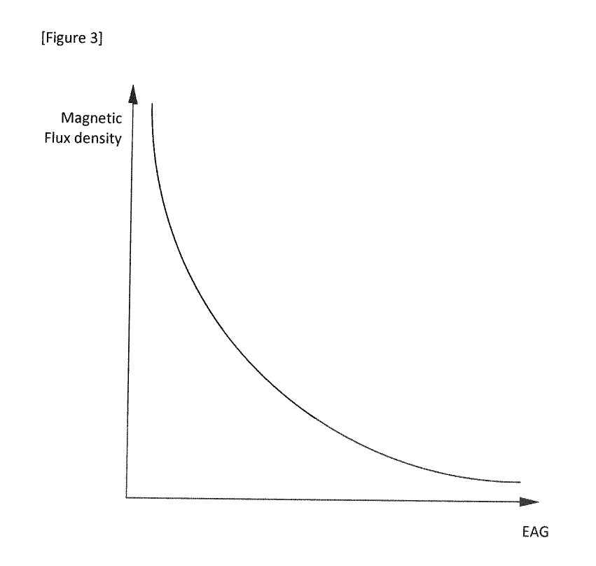

FIG. 4 illustrates the arrangement relation of the rotor and the Hall sensors in the BLDC motor;

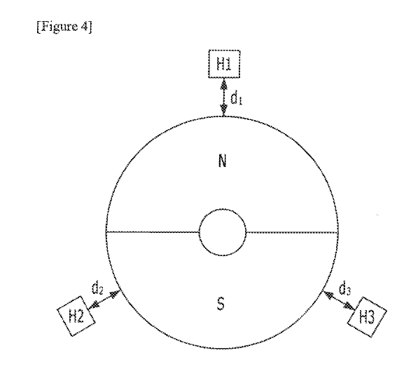

FIG. 5 is a graph showing the output signals of the Hall sensors in the BLDC motor of FIG. 4;

FIG. 6 is a block diagram of a device for correcting a Hall sensor installation position error in the BLDC motor having the linear Hall sensors according to one embodiment of the present invention;

FIG. 7 is a graph showing waveforms of output signals detected in a detection unit of the device for correcting a Hall sensor installation position error shown in FIG. 6;

FIG. 8 is a graph showing waveforms of normalized transformation signals output in a transformation unit of the device for correcting a Hall sensor installation position error shown in FIG. 6;

FIG. 9 is a flow chart of a method for correcting a Hall sensor installation position error in the BLDC motor having the linear Hall sensors according to the other embodiment of the present invention; and

FIG. 10 is a graph capturing a test result of detecting the rotation angle of the motor by using the device and method for correcting a Hall sensor installation position error according to the present invention, in detecting the rotation angle of the BLDC motor having the linear Hall sensors.

### DESCRIPTION OF NUMBERS FOR CONSTITUENTS IN DRAWINGS

110: detection unit
120: transformation unit
130: operation unit
140: control unit
S110: detecting step
S120: transforming step
S130: operating step
S140: controlling step

### DETAILED DESCRIPTION OF THE PREFERRED EMBODIMENT

A device and method for correcting a Hall sensor installation position in a BLDC motor with the linear hall sensor(s) according to the present invention will now be described more fully hereinafter with reference to the accompanying drawings. This invention has been described herein using example embodiments of the present invention to carry out the technical idea of the present invention. Therefore, it is to be understood that the scope of the invention is not limited to the disclosed example embodiments. On the contrary, the scope of the invention is intended to include various modifications and alternative arrangements within the capabilities of persons skilled in the art using presently known or future technologies and equivalents. The scope of the claims should be accorded the broadest interpretation so as to encompass all such modifications and similar arrangements.

Throughout the application, the “position of the motor” accurately means the “position of the rotor of the motor”. The “speed of the motor” accurately means the “speed of the rotor of the motor”. The term, “position”, means the angle that the rotor of the motor rotates from a reference point and is used as the same meaning of the “rotation angle” or “displacement”. Further, the term, “speed”, means the change rate of the position of the motor to time and is used as the same meaning of the “rotation speed”.

Further, the “device for correcting a Hall sensor installation position in the BLDC motor with the linear Hall sensors” according to the present invention may be briefly described as the “device for correcting a Hall sensor installation position. The “method for correcting a Hall sensor installation position in the BLDC motor with the linear Hall sensors” according to the present invention may be briefly described as the “method for correcting a Hall sensor installation position.

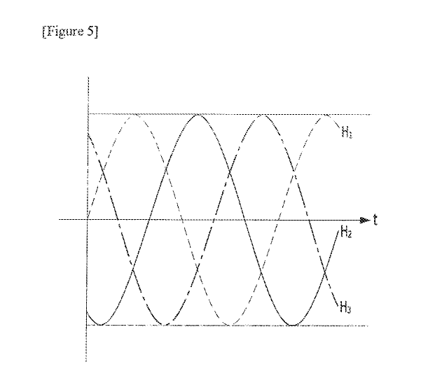

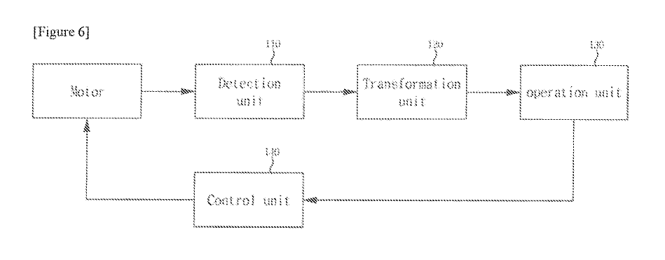

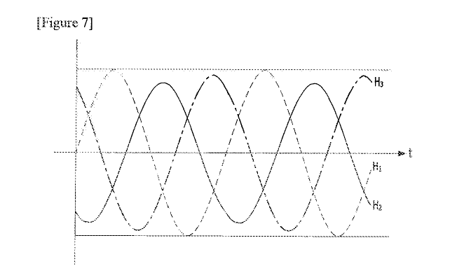

Referring to FIG. 6, the device for correcting a Hall sensor installation position in the BLDC motor with the linear Hall sensors according to the present invention includes a detection unit 110 to detect output signals from the three Hall sensors installed in the BLDC motor (hereinafter, referred to as the “motor”). For example, the output signals detected through the detection unit 110 are shown in FIG. 7. Distances d₁, d₂, d₃ between a permanent magnet of a rotor and each of the Hall sensors cannot be perfectly the same and are slightly difference from one another, due to the affect of an installation position error of the linear sensors H1, H2, H3. Therefore, unlike the ideal case shown in FIG. 5, output signals H₁, H₂, H₃ each output in the Hall sensors are different from one another in amplitude. In the embodiment of the present invention, the amplitude of output signal H₁ is greatest, the amplitude of output signal H₂ is smallest and the amplitude of output signal H3 is medium, as shown in FIG. 7.

To calculate the rotation angle of the rotor of the motor by using the three output signals H₁, H₂, H₃, a method is considered to normalize the maximum value and the minimum value of each of the output signals H₁, H₂, H₃. However, to this end, since the output signals need to be measured every moment while rotating the rotor more than one full turn, the quantity of operation of a controller increases. Further, since noise (singular value) affects, the maximum value and/or minimum value is changed to the singular value, causing a problem. Therefore, the present applicant proposes a more stable method, whereby the signals detected in the three linear hall sensors are transformed to a two-phase rotation domain, to be interpreted. Clarke Transformation (also called Alpha-beta Transformation) is known as being useful in interpreting by transforming three-phase circuits to an orthogonal two-phase rotating domain. The present applicant proposes a method of using the Clarke Transformation in detecting the rotation angle of the BLDC motor having the linear Hall sensors.

To this end, the device for correcting a Hall sensor installation position according to the present invention includes a transformation unit 120 to transform the output signals H₁, H₂, H₃ detected in the detection unit 110 to the sign wave of Hₐ (sine wave) and H_{b} (cosine wave) having the phase difference of 90° (degrees). To describe in more detail, the transformation unit 110 transforms the output signals H₁, H₂, H₃ to the signals Hₐ, H_{b} by Formula (2) and Formula (3) below:

$$\begin{matrix}{H}_{a} = \frac{2}{3} {H}_{1} - \frac{1}{3} ( {H}_{2} + {H}_{3} ) & Formula ( 2 ) \\ {H}_{b} = \frac{1}{\sqrt{3}} ( {H}_{2} - {H}_{3} ) & Formula ( 3 )\end{matrix}$$

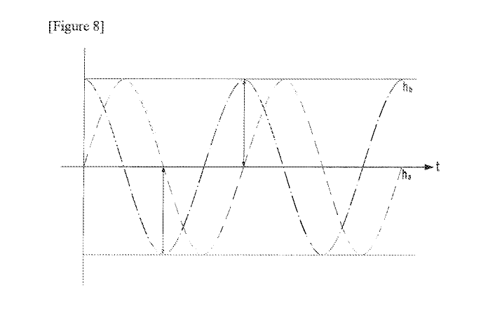

The signal waveforms represented by the transformation signals Hₐ, H_{b} are shown in FIG. 8. That is, Hₐ and H_{b} are represented as a sine wave and a cosine wave having the phase difference of 90° (degrees). Therefore, when Hₐ passes 0 (zero), H_{b} has the maximum value or minimum value and when H_{b} passes 0 (zero), Hₐ has the maximum value or minimum value. In other words, when H_{b} is detected at the point that Hₐ is 0 (zero), if H_{b} has a positive value, it is the maximum value and H_{b} has a negative value, it is the minimum value. When Hₐ is detected at the point that H_{b} is 0 (zero), if Hₐ has a positive value, it is the maximum value and Hₐ has a negative value, it is the minimum value. Each of Hₐ and H_{b} are normalized as Hₐₙ and H_{bn} by using the detected maximum and minimum values.

When the differences in the amplitude of the output signals H₁, H₂, H₃ output in the Hall sensors are great, that is, when the differences in the distances d₁, d₂, d₃ between the permanent magnet of the rotor and the Hall sensors are great, the phase difference of Hₐ and H_{b} may be out of 90° (degrees). In this case, it may be preferable to physically correct the installation position(s) of the Hall sensor(s) rather than to apply the device and method for correcting a Hall sensor installation position error according to the present invention. However, when the installation position(s) of the Hall sensor(s) is within a certain error range, that is, when the differences in the distances d₁, d₂, d₃ are not great, since the phase difference of Hₐ and H_{b} is not usually significantly out of 90° (degrees), the device and method for correcting a Hall sensor installation position error according to the present invention are more efficiently used.

The normalized transformation signals Hₐₙ and H_{bn} are used to calculate the rotation angle and rotation speed of the motor. To this end, the device for correcting a Hall sensor installation position error according to the present invention includes an operation unit 130 to calculate the rotation angle and rotation speed of the motor by using the normalized transformation signals Hₐₙ and H_{bn} output in the transformation unit 120.

The operation unit 130 calculates the rotation angle and rotation speed of the motor by the method disclosed in the '732 patent application as described above. To describe in more detail, when the normalized transformation signals Hₐₙ and H_{bn} are transformed as coordinates on the two-dimensional plane, the coordinates (x1, y1) of Hₐₙ and the coordinates (x2, y2) of H_{bn} are calculated and the angle (θ) that the sum P (x1+x2, y1+y2) of Hₐₙ and H_{bn} forms with the X-axis is calculated by the aforementioned method (Formula 1). The displacement of the angle (θ) represents the rotation angle of the motor. Further, the rotation speed of the motor is calculated by calculating the change rate of the calculated displacement to time.

As another method, the operation unit 130 is able to look for the rotation angle or speed of the motor by using any one of the coordinates (x1, y1) of Hₐₙ and the coordinates (x2, y2) of H_{bn}. That is, the displacement of the angle that any one of Hₐₙ and H_{bn}, instead of the sum P (x1+x2, y1+y2) of Hₐₙ and H_{bn}, forms with the X-axis may be calculated as the rotation angle of the motor. However, to increase the accuracy in calculating the rotation angle and speed of the motor, it is preferable to use the sum P (x1+x2, y1+y2) of Hₐₙ and H_{bn}.

The rotation angle and speed of the motor calculated in the operation unit 130 is transmitted to a control unit 140 to control the driving of the motor. The control unit 140 receives the information of the rotation angle of the motor, to control the current supplied to coils winding the stator.

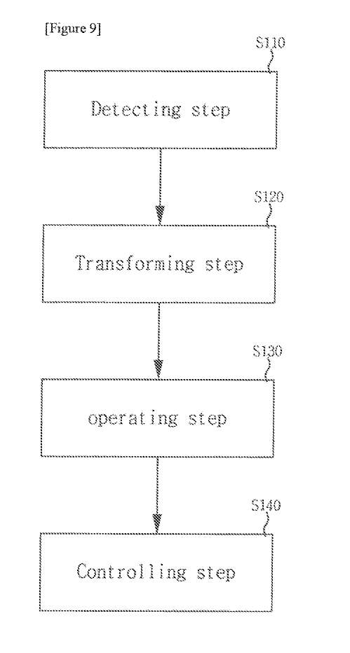

Referring to FIG. 9, the method for correcting a Hall sensor installation position error will be described by using the device for correcting a Hall sensor installation position error according to the present invention according to the present invention. The method for correcting a Hall sensor installation position error according to the present invention according to the present invention includes a detecting step S110 where the detection unit 110 detects the output signals H₁, H₂, H₃ from the three linear Hall sensors H1, H2, H3 installed in the motor. The detected output signals H₁, H₂, H₃ have the three sine wave forms and the waveforms may be different from one another in amplitude.

Next, a transforming step S120 is performed, where the transformation unit 120 transforms the output signals H₁, H₂, H₃ detected in the detecting step S110 by the Clarke Transformation and normalizes them. In the transforming step S120, the output signals H₁, H₂, H₃ detected in the detecting step S110 are transformed to sine waves Hₐ, H_{b} having the phase difference of 90° (degrees) and are normalized to output signals Hₐₙ and H_{bn}. The relations between the output signals H₁, H₂, H₃ and the transformation signals Hₐ, H_{b} are shown in Formula (2) and Formula (3) described above.

Next, an operating step S130 is performed, where the operation unit 130 calculates the rotation angle and rotation speed of the motor by using the normalized transformation signals Hₐₙ, H_{bn}. In the operating step S130, when the normalized transformation signals Hₐₙ and H_{bn} are transformed on the two-dimensional plane, the rotation angle and rotation speed of the motor are calculated by using the displacement of the angle (θ) that any one of the coordinates (x1, y1) of Hₐₙ, the coordinates (x2, y2) of H_{bn} and the sum P (x1+x2, y1+y2) of Hₐₙ and H_{bn} forms with the X-axis.

Next, a controlling step S140 is performed, where the control unit 140 controls the current supplied to the motor by using the rotation angle and rotation speed of the motor calculated in the operating step S130. In the controlling step S140, the current supplied to each of the coils of the stator is controlled according to the position of the rotor of the motor.

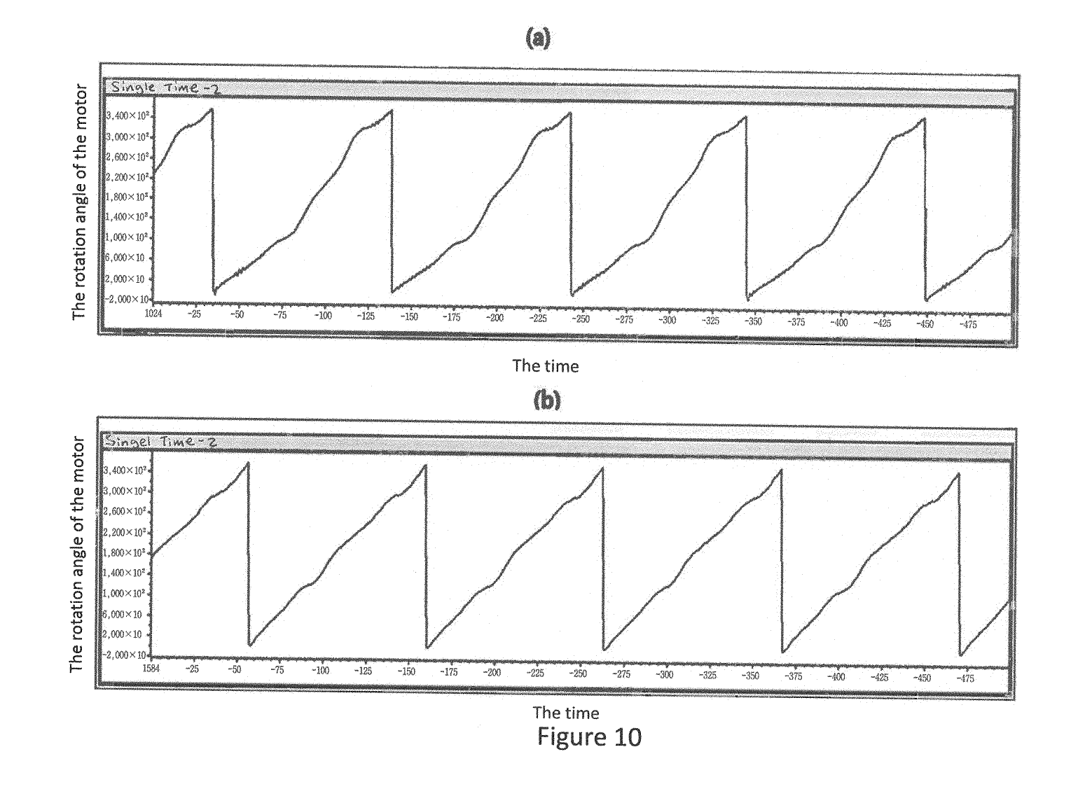

FIG. 10 is a graph capturing a test result of detecting the rotation angle of the motor, by using the device and method for correcting a Hall sensor installation position error according to the present invention. In this test, the rotation angle of the motor is calculated by rotating the motor at uniform velocity. In FIG. 10, (a) is the result of calculating the rotation angle of the motor by using the output signals H₁, H₂, H₃ of the Hall sensors H1, H2, H3. The rotation angle of the motor (Y-axis) according to the time (X-axis) is shown. The rotation angle of the motor does not linearly increase and unevenly increases by the affect of the installation position error of the linear Hall sensors. Under the same test conditions, the rotation angle of the motor has been calculated by using the device and method for correcting a Hall sensor installation position error according to the present invention. That is, in FIG. 10, (b) shows the result of calculating the rotation angle of the motor by using the transformation signals Hₐₙ and H_{bn} normalized from the output signals H₁, H₂, H₃ of the Hall sensors. Compared with (a) of FIG. 10, it is apparent that the rotation speed of the motor increases more closely to the linear shape. That is, it is confirmed that the accuracy in the calculation of the rotation angle of the motor has been improved.

The above description is based on the 2-pole motor, however, the present invention may be used for a 4-pole motor, a 6-pole motor, a 8-pole motor or a multi-pole motor in the same manner.

As described above, the device and method for correcting a Hall sensor installation position error according to the present invention has the effect of accurately calculating the rotation angle and rotation speed of the motor even if a slight error exists such that the Hall sensor(s) installed in the motor is not installed at the normal position. When the device and method for correcting a Hall sensor installation position error according to the present invention is used, since an error in the installation position of the Hall sensor(s) may not be modified, the productivity of the motor(s) increases and the production cost is reduced.

What is claimed is:

1. A device for correcting a Hall sensor installation position error in a BLDC motor which includes a rotor with a permanent magnet, a stator wound with coils to form a magnetic field around the rotor, and three linear Hall sensors installed outwardly around the rotor to generate output signals by the Hall-Effect, the device comprising:
a detection unit to detect output signals H₁, H₂, H₃ output from the three linear Hall sensors;
a transformation unit to transform the output signals H₁, H₂, H₃ detected in the detection unit to orthogonal two-phase transformation signals Hₐ, H_{b} and to transform the transformation signals Hₐ, H_{b} to normalized transformation signals Hₐₙ, H_{bn};
an operation unit to calculate a rotation angle of the motor from the normalized transformation signals Hₐₙ, H_{bn} output in the transformation unit; and
a control unit to control the current supplied to the coils winding the stator based on information of the rotation angle transmitted from the operation unit.

2. The device according to claim 1, wherein the transformation unit transforms the output signals H₁, H₂, H₃ to the orthogonal two-phase transformation signals Hₐ, H_{b} by Clarke Transformation.

3. The device according to claim 2, wherein the transformation unit transforms the output signals H₁, H₂, H₃ to the orthogonal two-phase transformation signals Hₐ, H_{b} by the following Formulae:
$${H}_{a} = \frac{2}{3} {H}_{1} - \frac{1}{3} ( {H}_{2} + {H}_{3} ) , {H}_{b} = \frac{1}{\sqrt{3}} ( {H}_{2} - {H}_{3} )$$

4. The device according to claim 2, wherein the operation unit calculates the rotation angle of the motor by using the displacement of an angle (θ) that the sum P (x1+x2, y1+y2) of Hₐₙ and H_{bn} forms with the X-axis when the normalized transformation signals Hₐₙ and H_{bn} are transformed as the coordinates (x1, y1) of Hₐₙ and the coordinates (x2, y2) of H_{bn} on the two-dimensional plane.

5. A method for correcting a Hall sensor installation position error in a BLDC motor which includes a rotor with a permanent magnet, a stator wound with coils to form a magnetic field around the rotor, and three linear Hall sensors installed outwardly around the rotor to generate output signals by the Hall-Effect, the method comprising:
a detecting step of detecting output signals H₁, H₂, H₃ output from the three linear Hall sensors;
a transforming step of transforming the output signals H₁, H₂, H₃ detected at the detecting step to orthogonal two-phase transformation signals Hₐ, H_{b} and transforming the transformation signals Hₐ, H_{b} to normalized transformation signals Hₐₙ, H_{bn};
an operating step of calculating a rotation angle of the motor from the normalized transformation signals Hₐₙ, H_{bn} output in the transformation unit; and
a controlling step of controlling the current supplied to the coils winding the stator based on information of the rotation angle transmitted from the operation unit.

6. The method according to claim 5, wherein the transforming step transforms the output signals H₁, H₂, H₃ to the orthogonal two-phase transformation signals Hₐ, H_{b} by the following Formulae:
$${H}_{a} = \frac{2}{3} {H}_{1} - \frac{1}{3} ( {H}_{2} + {H}_{3} ) , {H}_{b} = \frac{1}{\sqrt{3}} ( {H}_{2} - {H}_{3} )$$

7. The method according to claim 5, wherein the operating step calculates the rotation angle of the motor by using the displacement of an angle (θ) that the sum P (x1+x2, y1+y2) of Hₐₙ and H_{bn} forms with the X-axis when the normalized transformation signals Hₐₙ and H_{bn} are transformed as the coordinates (x1, y1) of Hₐₙ and the coordinates (x2, y2) of H_{bn} on the two-dimensional plane.
